(19) United States
(12) Patent Application Publication
(10) Pub. No.: US 2023/0111327 A1
(43) Pub. Date: Apr. 13, 2023

(54) TECHNIQUES FOR FINDING AND ACCESSING VEHICLES

(71) Applicant: Motional AD LLC, Boston, MA (US)

(72) Inventors: Felice Ling, Cambridge, MA (US); Tristan Dwyer, Stow, MA (US); Linh Hong Pham, Cambridge, MA (US); Christopher Konopka, Peabody, MA (US)

(21) Appl. No.: 17/497,773

(22) Filed: Oct. 8, 2021

(51) Int. Cl. H04W 4/024; G06T 11/00; G06V 40/20; G06V 10/74; G06V 10/82; B60R 25/20; B60R 25/10; B60R 25/31; B60R 25/102; G06N 3/04

(52) U.S. Cl. CPC H04W 4/024; B60R 25/31; B60R 25/102; B60R 25/1003; B60R 25/2045; G06N 3/04; G06T 11/00; G06V 10/74; G06V 10/82; G06V 40/28

(57) ABSTRACT

The disclosed embodiments generally provide visual and/or audio cues to a user to guide the user to a vehicle pickup-drop-off (PuDo) location, such as an autonomous vehicle (AV) PuDo. The user’s current location is determined based on information from the user’s mobile device. A path is determined from the user’s current location to the designated PuDo location, and instructions (e.g., turn-by-turn directions) to reach the designated PuDo are displayed on the user’s mobile device, for example, using an augmented reality (AR) interface on their mobile device that is updated in real-time. Disclosed embodiments also allow vehicles to authenticate the identity of a user before allowing entry of the user into the vehicle based on a sequence of hand gestures performed by the user that are detected by exterior sensors (e.g., camera, LiDAR) of the vehicle.

### BACKGROUND

Online transportation companies have become ubiquitous in most major cities throughout the world. A mobile application on their mobile device (e.g., smartphone, smartwatch) to request a ride by specifying a pick-up/drop-off (PuDo) location and other information. A vehicle is then dispatched to the PuDo. The user can watch the progress of the vehicle traveling to the PuDo on a map displayed on their mobile device, and the user is notified by a text message or other alert when their assigned vehicle has arrived. For users who are blind or vision-impaired, however, finding a PuDo can be challenging, and can lead to ride cancellations. Visually impaired users often solve this navigation problem by calling the driver of the vehicle for help. This solution, however, does not work if the vehicle is an autonomous vehicle (AV).

Additionally, research has shown that many users have difficulties finding their assigned vehicles. These difficulties include inaccurate location information, imprecise location markers and mobile applications that do not accurately portray the PuDo environment, such as located near a construction site, bad or missing signage and the like. To add to this confusion, finding the assigned vehicle is often an “chance” meeting, where a passenger is speaking with their driver using their mobile device with each frantically attempting to communicate their location to the other.

Another problem often cited by users is accessing the vehicle after it is located. When the user enters a vehicle, a human driver unlocks a passenger door of the vehicle, verifies the user’s identity and confirms the user’s destination. With autonomous vehicles, however, users need to find new ways to unlock, enter and verify that they are in the correct vehicle. Existing access solutions rely on the user’s mobile device for access and authentication using short range communication with the vehicle computer. These solutions, however, are not available when a passenger’s mobile device is not accessible or has low or no battery life. Accessing the vehicle using remote control assistance (RVA) works for some passengers, but for other users who are, for example, hearing impaired, another solution is needed.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4 is a diagram of certain components of an autonomous system;

FIG. 5 is a diagram illustrating remote vehicle assistance (RVA) guided navigation;

FIG. 6 illustrates navigation using audio and haptic feedback;

FIGS. 7A-7C illustrate navigation using magnetic fields, smell and sound for service animals, respectively;

FIGS. 8A-8E illustrate using a mobile device to assist a user in finding a PuDo location utilizing a mobile device;

FIG. 9 illustrates a system for accessing a vehicle using a series of hand gestures;

FIG. 10 illustrates a process flow for accessing a vehicle using a series of hand gestures;

FIG. 11 is a flow diagram of a process for assisting a user to find a vehicle; and

FIG. 12 is a flow diagram of a process for accessing a vehicle using a sequence of hand gestures.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

In some aspects and/or embodiments, systems, methods, and computer program products described herein include and/or implement technology for finding and accessing a vehicle, and in particular for users who are blind, visually-impaired or hearing impaired.

The disclosed embodiments generally provide visual and/or audio cues to a user to guide the user to a vehicle, such as an AV. For example, the user’s current location is determined based on information from the user’s mobile device (e.g., a smartphone). A path is determined from the user’s current location to a designated PuDo location, and instructions to reach the designated PuDo location are displayed on the user’s mobile device, for example, using an augmented reality (AR) interface on their mobile device that is updated in real time.

The disclosed embodiments also allow vehicles to authenticate the identity of a user before allowing entry of the user into the vehicle based on a sequence of hand gestures performed by the user that are detected by exterior sensors (e.g., cameras, LiDAR) of the vehicle. For example, during an initialization procedure a user can choose a sequence of preferred hand gestures to be stored in association with their user profile. When the user approaches a vehicle, the user performs the sequence of hand gestures to gain entry to the vehicle. Sensors (e.g., cameras) installed on the exterior of the vehicle detect the sequence of hand gestures. The sequence of hand gestures are compared with the sequence of hand gestures stored in the user profile. If the sequence of hand gestures matches the stored sequence to within a desired threshold, the user’s identity is authenticated and the user is allowed to enter the vehicle by automatically unlocking one or more doors of the vehicle.

By virtue of the implementation of systems, methods, and computer program products described herein, techniques for finding and accessing a vehicle provide at least the following advantages.

A user’s personal mobile device is leveraged to provide assessable and intuitive guidance instructions to a PuDo location. A dynamic distance graphic helps the user understand the user’s progress towards the designated PuDo location. An electronic compass on the mobile device helps the user locate quickly the designated PuDo location when the user is in the immediate vicinity of the PuDo location. AR and/or physical end markers (e.g., signs, landmarks) further assist the user in locating the designated PuDo location among several PuDo locations.

Using hand gestures to authenticate in real-time the identity of a user provides an accessible way for a hearing-impaired user to safely enter a vehicle. For example, a vehicle that is capable of recognizing ASL (American Sign Language) or other established sign languages or common touch screen gestures (e.g., clenching, pinching, waving), provides better real-time accessibility for hearing impaired users. The hand-tracking technology used to detect hand gestures is adaptable to different types of vehicles. The real-time detection of hand gestures minimizes passenger waiting time. A modifiable sequence of hand gestures ensures passenger privacy.

In an embodiment, a method comprises: obtaining, from sensors of a mobile device of a user (e.g., a personal smartphone or tablet), sensor data (e.g., GNSS data or triangularized location data from WIFI, Bluetooth™, cell towers) indicative of a location of the mobile device; obtaining, by at least one processor of the mobile device, position data indicative of a designated PuDo location; determining, by the at least one processor of the mobile device, based on the sensor data and the position data, a path from the current location of the mobile device to the designated PuDo location; determining, by the at least one processor of the mobile device, based on the path, a set of instructions to follow the path (e.g. turn-by-turn directions); providing, using an interface of the mobile device, by the at least one processor of the mobile device, information comprising an indication (e.g. an AR marker or a physical marker, such as signage) associated with the designated PuDo location; and a set of instructions to follow the path based on the current location of the mobile device.

In an embodiment, the method further comprises: determining a distance from the current location of the mobile device to the designated PuDo location based on the path; and providing, using the interface of the mobile device, information comprising a distance from the current location of the mobile device to the designated PuDo location.

In an embodiment, the indication is associated with (e.g., represents) at least one of physical feature or landmark located in an environment (e.g., a building, a traffic light or a physical marker), or an AR marker displayed on the user’s mobile device located relative to at least one object in the environment displayed on the mobile device.

In an embodiment, the AR marker is unique within a geographical region (e.g., multiple copies of one AR marker may exists within the Boston, but only one such AR marker exists within 1 mile of South Station) and is associated with the arriving vehicle (e.g., an AR marker can be visually associated with the vehicle) scheduled to arrive at the designated PuDo location.

In an embodiment, the set of instructions comprises a set of visual cues overlaid onto a live video feed of the environment (e.g., a set of AR arrows overlaid on a live video stream and directed towards the designated PuDo location following the path).

In an embodiment, the set of instructions comprises an compass (e.g., a graphic or AR compass) pointing in the direction of the designated PuDo location.

In an embodiment, the compass is displayed when the mobile device is within a threshold distance of the designated PuDo location.

In an embodiment, the path from the current location of the mobile device to the designated PuDo location is determined at least in part by a network-based computing system (also referred to as a “cloud computing system”).

In an embodiment, the set of instructions is determined at least in part by the network-based computing system.

In an embodiment, the distance from the current location of the mobile device to the designated PuDo location is determined at least in part by the network-based computing system.

In an embodiment, the set of instructions is determined at least in part by the network-based computing system.

In an embodiment, the sensor data comprises at least one of satellite data, wireless network data or location beacon data.

In an embodiment, the method further comprises updating, by the at least one processor of the mobile device, the provided information based on a new location of the mobile device.

In an embodiment, a method comprises: obtaining, by at least one processor of a vehicle, a stored sequence (e.g., saved in a user profile of a NFC device belonging to the user or on a network server) of hand gestures of a user; obtaining, by the at least one processor, sensor data (e.g., camera data or LiDAR data) associated with the sequence of hand gestures performed by the user (e.g., when the user is within a threshold distance of the vehicle); identifying, by the at least one processor, the sequence of hand gestures performed by the user based on obtaining the sensor data; comparing, by the at least one processor, the sequence of hand gestures performed by the user and the stored sequence of hand gestures based on identifying the sequence of hand gestures performed by the user and the stored sequence of hand gestures; determining, by the at least one processor, that the sequence of hand gestures performed by the user matches the stored sequence of hand gestures in the user’s profile based on comparing the sequence of hand gestures performed by the user and the stored sequence of hand gestures (e.g., matching the stored sequence by threshold percentages of a set of respective matching metrics); unlocking, by the at least one processor, at least one door of the vehicle based on determining that the sequence of hand gestures performed by the user matches the stored sequence of hand gestures of the user.

In an embodiment, the method further comprises providing a notification of the unlocking (e.g., through display of signage, lights, etc.) through an interface on the exterior of the vehicle.

In an embodiment, the method further comprises: determining (e.g., recognizing and/or calculating) based on the sensor data, a user location relative to the vehicle; and opening the at least one door (or cargo space) closest to the user location.

In an embodiment, the method of any of the preceding method claims, further comprises providing a notification of the opening through an interface on the exterior of the vehicle prior to the opening.

In an embodiment, the method of any of the preceding claims, further comprises: determining, based on a request from the passenger, that the passenger requires remote assistance; contacting at least one remote vehicle assistance (RVA) based on determining that the user requires remote assistance, receiving, from the at least one RVA, data associated with instructions to gain access to the vehicle, and providing the instructions through the interface on the exterior of the vehicle.

In an embodiment, the stored sequence is obtained at least in part based on data from a short-range communication (e.g., NFC, Bluetooth) device.

In an embodiment, identifying a sequence of hand gestures performed by the user is based on a machine learning (ML) model (e.g., a recurrent neural network trained to recognize a sequence of hand gestures).

In an embodiment, the ML model is a recurrent neural network (e.g., trained to recognize hand gestures and the ordering of the hand gestures).

In an embodiment, identifying the sequence of hand gestures performed by the user comprises identifying, using a remote system (e.g., a cloud server), at least one gesture in the sequence of gestures performed by the user.

In an embodiment, a system comprises: at least one processor; and at least one non-transitory, computer-readable storage media comprising instructions that, upon execution of the instructions by the at least one processor, cause the at least one processor to perform, in whole or in part, any one of the methods described above.

In an embodiment, at least one non-transitory, computer-readable storage media comprising instructions that, upon execution of the instructions by at least one processor, cause the at least one processor to perform, in whole or in part, any of the methods described above.

In an embodiment, an apparatus comprises means to perform, in whole or in part, any of the methods described above.

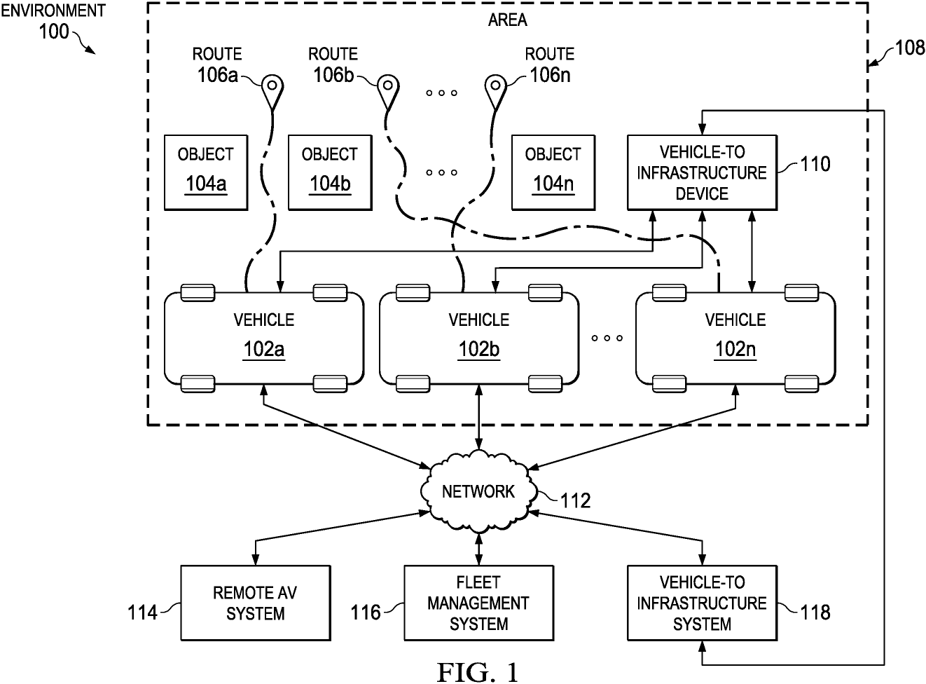

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote AV system 114, fleet management system 116, and V2I system 118. Vehicles 102a-102n, vehicle-to-infrastructure (V2I) device 110, network 112, AV system 114, fleet management system 116, and V2I system 118 interconnects (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, AV system 114, fleet management system 116, and V2I system 118 via wired connections, wireless connections, or a combination of wired or wireless connections.

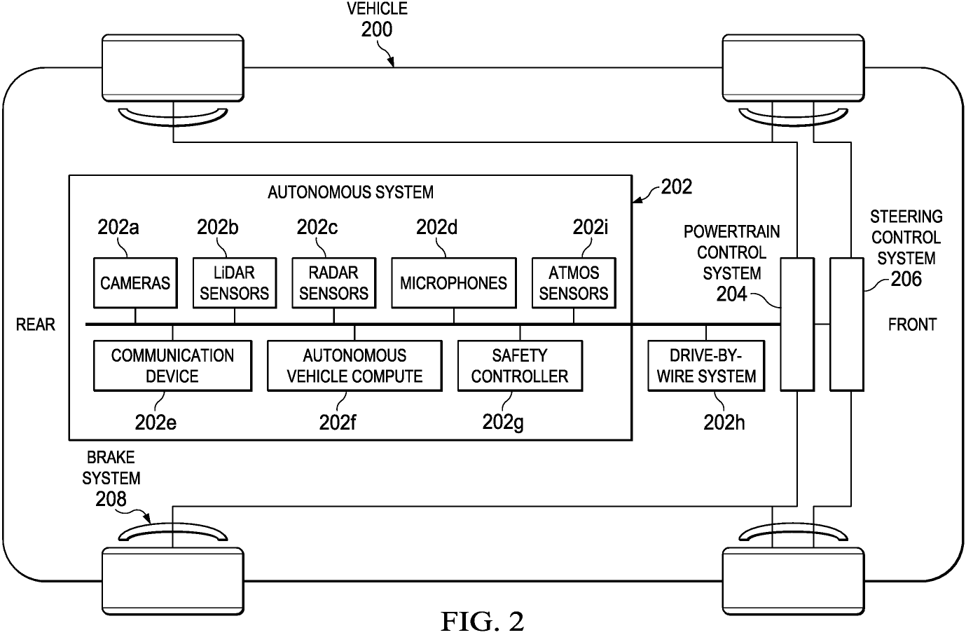

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g., a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, remote AV system 114, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 have autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International’s standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

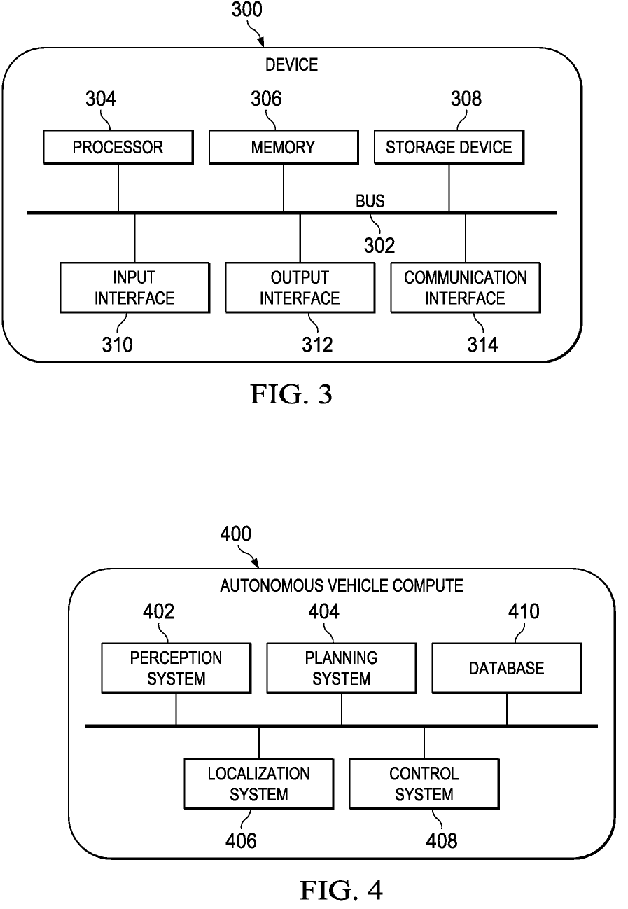

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e include at least one device configured to be in communication with cameras 202a, LiDAR sensors 202b, radar sensors 202c, microphones 202d, autonomous vehicle compute 202f, safety controller 202g, and/or DBW system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like) a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

In some embodiments, vehicle 200 includes at least one atmospheric sensor 202i that measure atmospheric conditions surrounding vehicle 200, including but not limited to: barometric pressure sensors, temperature sensors, humidity/rain sensors, ambient light sensors, etc.

Referring now to FIG. 3, illustrated is a schematic diagram of a device 300. As illustrated, device 300 includes computer processor 304, memory 306, storage component 308, input interface 310, output interface 312, communication interface 314, and bus 302. In some embodiments, device 300 corresponds to at least one device of vehicles 102 (e.g., at least one device of a system of vehicles 102), at least one device of, and/or one or more devices of network 112 (e.g., one or more devices of a system of network 112). In some embodiments, one or more devices of vehicles 102 (e.g., one or more devices of a system of vehicles 102), and/or one or more devices of network 112 (e.g., one or more devices of a system of network 112) include at least one device 300 and/or at least one component of device 300. As shown in FIG. 3, device 300 includes bus 302, computer processor 304, memory 306, storage component 308, input interface 310, output interface 312, and communication interface 314.

Bus 302 includes a component that permits communication among the components of device 300. In some embodiments, computer processor 304 is implemented in hardware, software, or a combination of hardware and software. In some examples, computer processor 304 includes a computer processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by computer processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally, or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on computer processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause computer processor 304 to perform one or more processes described herein. Additionally, or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by computer processor 304 and/or by a computer processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally, or alternatively, a set of components (e.g., one or more components) of device 300 can perform one or more functions described as being performed by another component or another set of components of device 300.

Referring now to FIG. 4, illustrates is an example block diagram of an AV compute 400 (sometimes referred to as an “AV stack”). As illustrated, AV compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits [ASICs], Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of AV compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

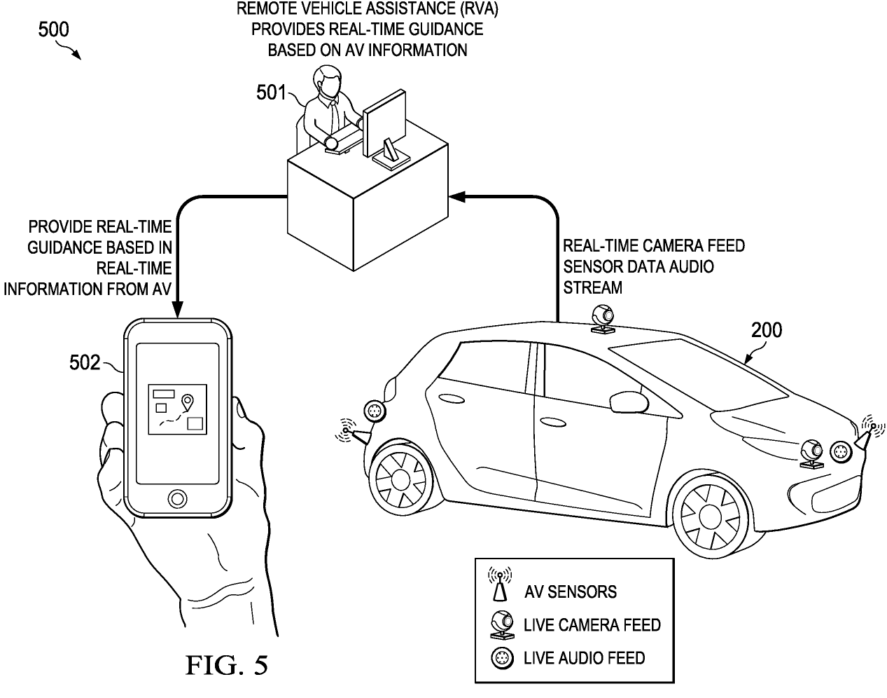

FIG. 5 is a diagram illustrating RVA guided navigation. In an embodiment, upon signing up to use a rob taxi service (e.g., via an online service or mobile application), users fill out a user profile, through which the user responds to questions or provides other information to self-identify as blind, visually impaired or hearing-impaired, and further indicate whether or not they utilize a service animal, white cane or hearing device for navigation. These users are then presented with options for direction guidance to a designated PuDo location for boarding the vehicle, and from the destination PuDo location to their final destination.

In an embodiment, an RVA 501 (e.g., a remote human or virtual teleoperator) provides real-time guidance to assist the user in navigating to a vehicle PuDo location based on vehicle information provided by vehicle 200. The vehicle information can include but is not limited to the current location and heading of the vehicle 200. The location data can be determined by a localization module (e.g., localization system 406) using a global satellite navigation system (GNSS) receiver (e.g., a GPS receiver ), or wireless network signals from, e.g., a WIFI network, a cellular network or location beacons (e.g., Bluetooth low energy (BLE) beacons). Heading data can be referenced from true North and is provided by an electronic compass onboard vehicle 200 (e.g., magnetometer(s)). In addition, vehicle 200 provides to RVA 501 a real-time or “live” camera feed(s) from at least one external facing camera mounted to vehicle 200 and/or point cloud data from at least one depth sensor (e.g., LiDAR, RADAR, SONAR, TOF sensors) mounted to vehicle 200 (e.g., mounted on the roof of vehicle 200). In an embodiment, vehicle 200 also provides RVA 501 with a live audio feed capturing ambient sound in the operating environment using one or more microphones located on vehicle 200. This vehicle information is then used by RVA 501, together with the current location and heading of the mobile device data to provide real-time guidance to the user through their mobile device 502, e.g., through a telephone call, text message or push notification. For example, RVA 501 can provide turn-by-turn directions to the user through a loudspeaker or headphones coupled to their mobile device 502 or through other modes of communication. The guidance can be provided by a human teleoperator at RVA 501 or can be computer generated (e.g., a virtual or digital assistant) at RVA 501.

In an embodiment, when vehicle 200 approaches the user’s current location, the user receives a phone call, push notification or haptic alert (e.g., a vibration) on their mobile device from RVA 501. RVA 501 gives verbal directions to the user for navigating to the PuDo location of vehicle 200. The directions are based on the user’s location and/or camera feed(s) from vehicle 200. In particular, RVA 501 provides verbal directions based on a number of data, including but not limited to: GNSS data (e.g., latitude, longitude, altitude, heading, speed) obtained from the user’s mobile device, the user’s camera data to gain context on what objects are around the user (e.g., “There is a tree immediately in front of you. Touch that tree, then turn left”) and the vehicle’s camera(s) to understand the context of where the vehicle 200 is in relation to the user. In an embodiment, when the user is with a threshold radial distance from vehicle 200 (e.g., within 100 ft radius ), RVA 501 provides verbal guidance, or other audible signals (e.g., beep pattern) through external loudspeakers of vehicle 200 to guide the user in the direction of vehicle 200.

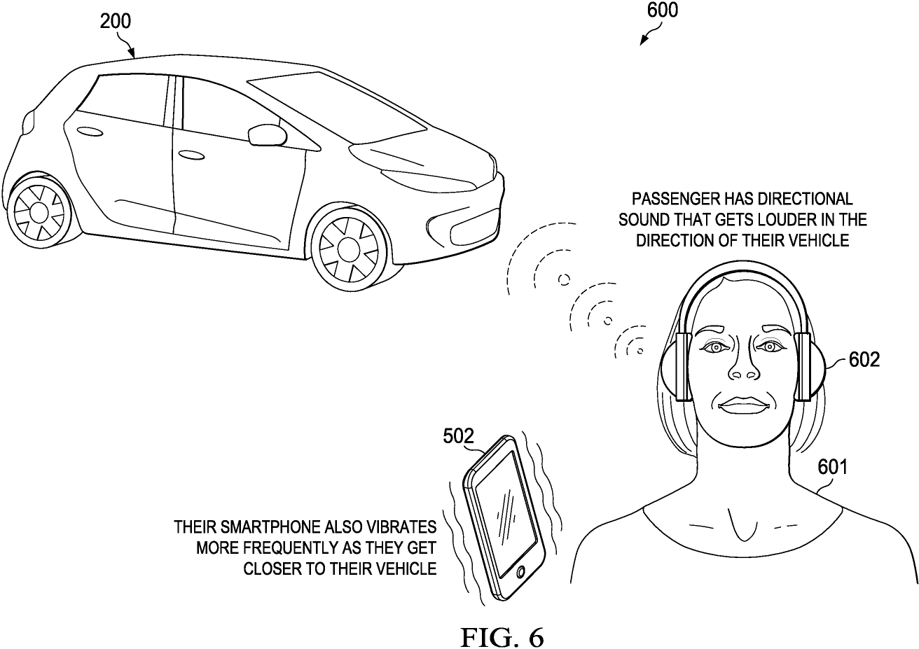

FIG. 6 illustrates navigation using audio and haptic feedback. In an embodiment, after booking vehicle 200 (e.g., similar to AV system 114) user 601 puts on a set of headphones 602 coupled to mobile device 502 (e.g., wired or wirelessly coupled to their smartphone/smartwatch). When vehicle 200 approaches the user 601, spoken directions are communicated through headphones 602. The volume level of the spoken directions incrementally increases as the user approaches vehicle 200. In another embodiment, a haptic engine embedded on mobile device 502 vibrates with increasing frequency, or vibrates with a different pattern or intensity the closer user 601 gets to vehicle 200. Similarly, as user 601 moves away from vehicle 200, the volume of spoken directions and/or the vibration frequency of the haptic engine gradually or incrementally decreases.

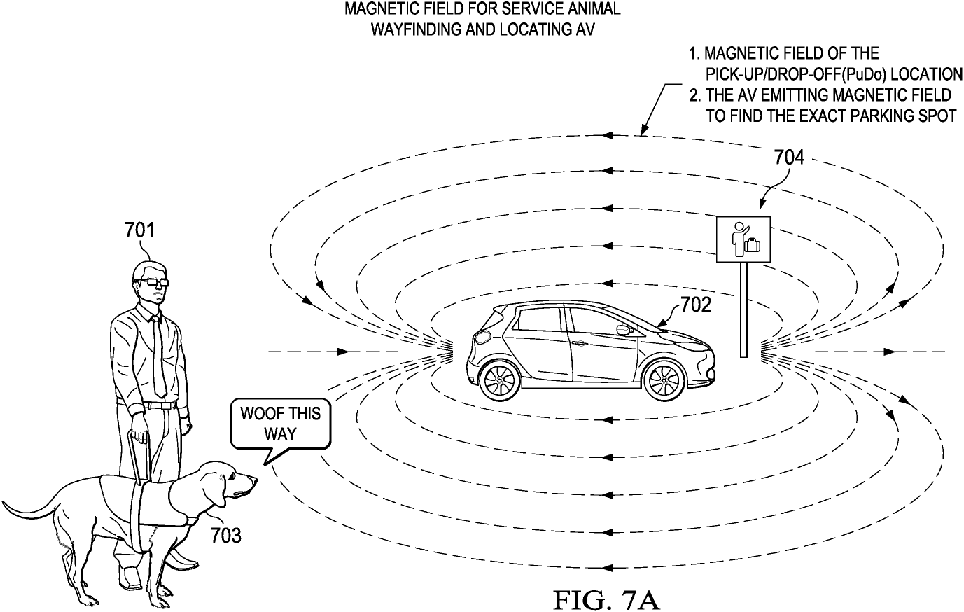

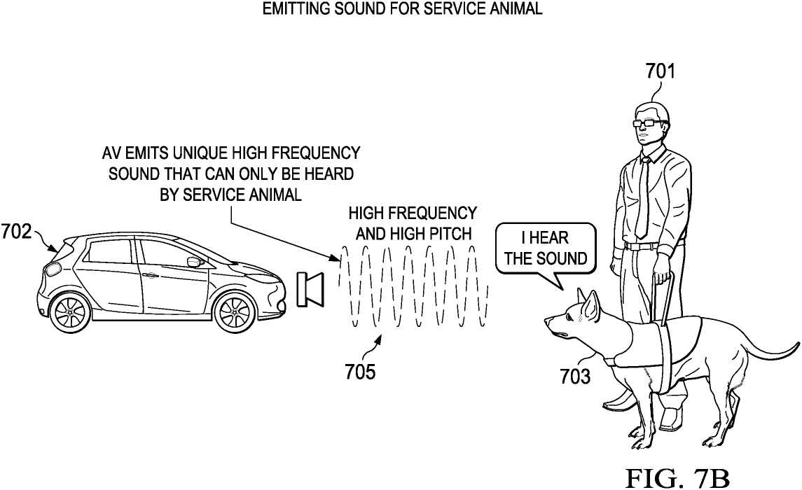

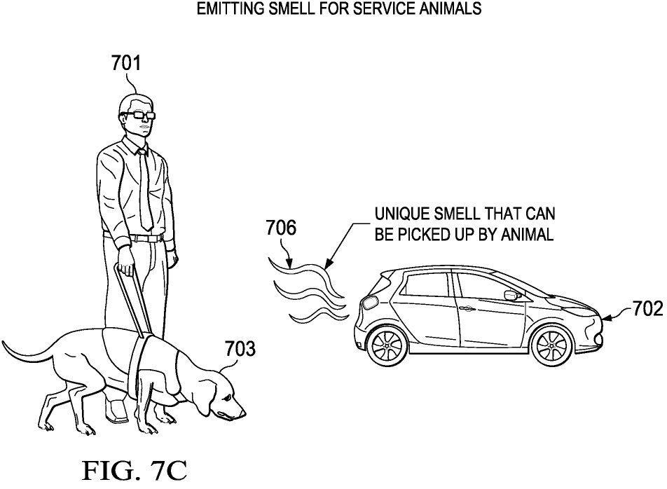

FIGS. 7A-7C illustrate navigation using magnetic fields, smell and sound for service animals, respectively. Service animals are working animals that have been trained to perform tasks that assist disabled people. Service animals can include guide animals (e.g., guide dogs), which guide the blind or visually-impaired, hearing animals, which signal the hearing-impaired, and other service animals, which do work for persons with disabilities other than blindness or deafness.

Referring to FIG. 7A, a transmitter can be installed at vehicle PuDo location 704 (e.g., installed on signage or utility pole) that generates a magnetic field that can be detected by service animal 703, and used to guide the service animal 703, and therefore user 701 to vehicle PuDo location 704. Dogs are sensitive to small variations of the Earth’s magnetic field, and research has proven that dogs can use this sense for navigation and wayfinding. In another embodiment, a magnetic field can be transmitted by vehicle 702 when parked at vehicle PuDo location 704. In another embodiment, vehicle PuDo location 704 may be a parking space with a parking sensor that emits magnetic fields that can be sensed by service animal 703, and thus used to guide service animal 703 and therefore user 701 to vehicle PuDo location 704.

Referring to FIG. 7B, vehicle 702 (or a device installed at vehicle PuDo location 704) emits a unique high frequency sound 705 that can only be heard by service animal 703 (e.g., great than 20 KHz), and thus used to guide service animal 703 and thereby user 701 to vehicle 702. Ultrasonic sensors are widely used in cars as parking sensors to aid the driver in reversing into parking spaces and assisting in AV navigation. In an embodiment, these ultrasonic signals can be used to guide service animal and thereby users to vehicle PuDo locations.

Referring to FIG. 7C, vehicle 702 (or vehicle PuDo location 704) emits a unique odor 706 that can be detected by service animal 703 and used to guide service animal 703, and thereby user 701 to vehicle 702.

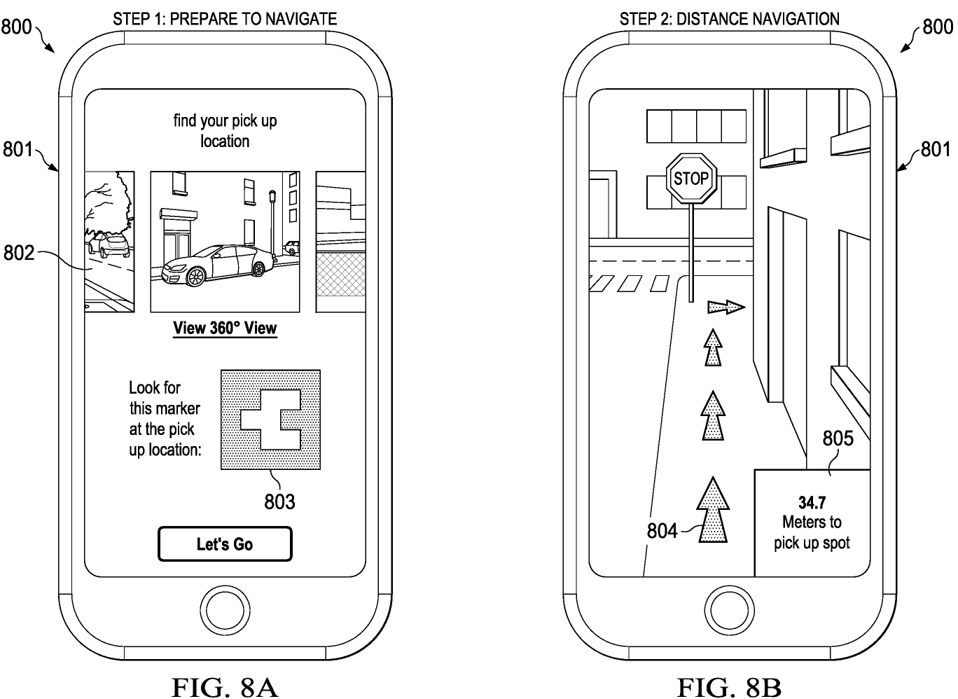

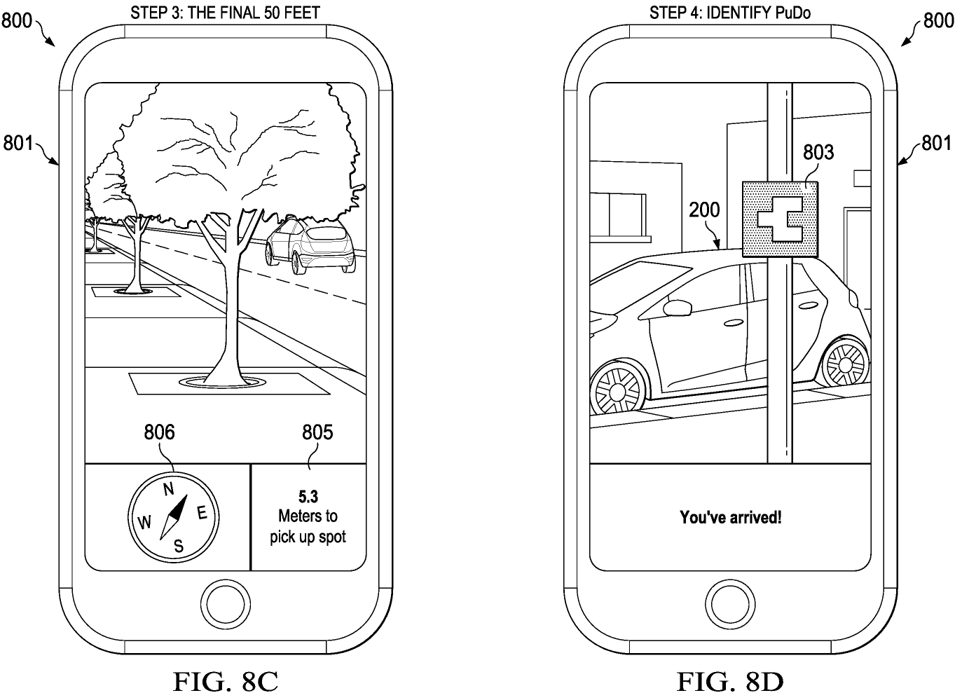

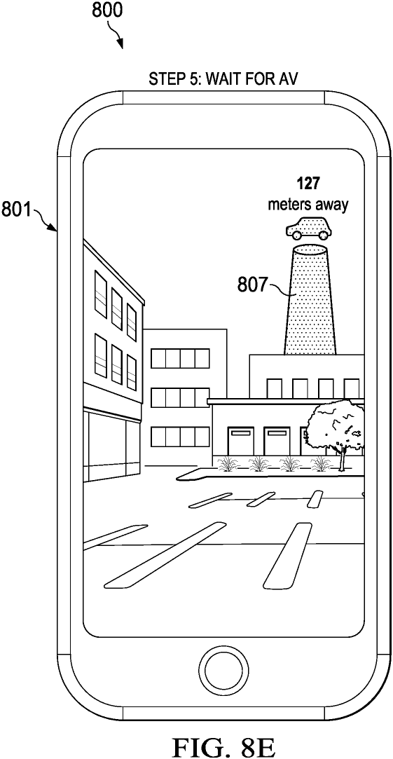

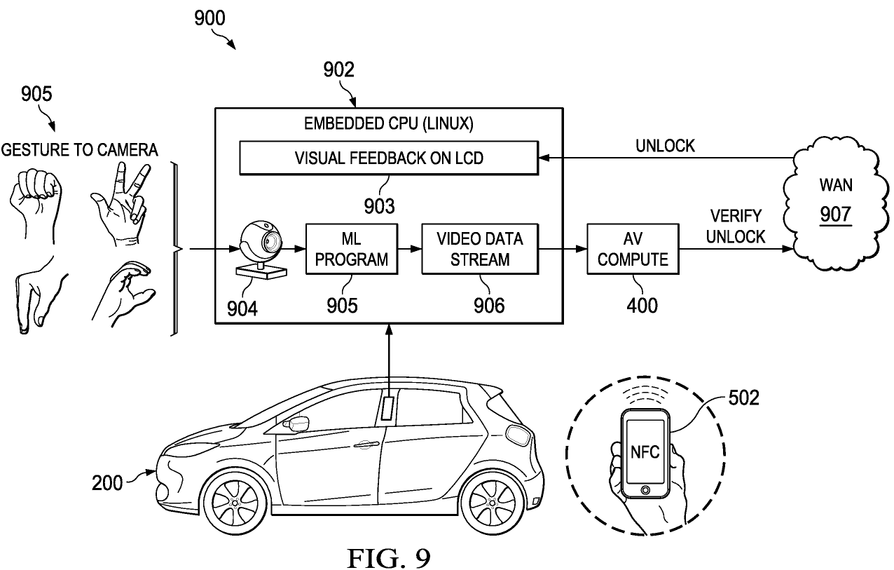

FIGS. 8A-8E illustrate an integrated system 800 that allows a mobile device 801 to assist a user in finding their designated PuDo location. Referring to FIG. 8A, using mobile device 801 (e.g., smartphone, smartwatch), users can view 360 degree photos/videos 802 of their PuDo location, as viewed through at least one camera or depth sensor on the vehicle. For example, the vehicle can provide a live video feed from at least one camera that can be received directly (e.g., through WIFI, Bluetooth, 5G) or indirectly (e.g., through communication device 202e) by mobile device 801. Additionally, users are presented with a graphic or image of a final end marker 803 at the PuDo location, so that the user can easily recognize the end marker 803 when they arrive at the PuDo location. End marker 803 can be physical signage that displays a symbol, bar code, QR code or any other visual cue that uniquely identifies the PuDo location. End marker 803 can also be an AR object that is overlayed on a live video feed displayed by mobile device 801, as shown in FIG. 8E. Each PuDo location can be assigned a unique symbol, bar code or QR code in a particular geographic region. End markers 803 can be installed on signage, utility poles or any other infrastructure at the PuDu location. When the vehicle is parked at the PuDo location, an external display screen (e.g., access device 903 shown in FIG. 9 attached to the B-frame) or a laser/LED projection made by the vehicle on the ground can display the end marker 803 to distinguish the vehicle from other vehicles that may be parked or using the same PuDo location (e.g., a designated PuDo location at an airport, train station, entertainment venue or other public location).

Referring to FIG. 8B, the user can invoke a navigation application on mobile device 801 that provides real-time turn-by-turn directions to the PuDo location. Users can navigate to the PuDo location by following the turn-by-turn directions. In an embodiment, the navigation application uses AR markers 804 (e.g., direction arrows) on a live video feed that can be used to assist in guiding the user to their PuDo location. Physical markers (e.g., orange parking cones) can also be used for additional guidance. Also, a number AR distance meter 805 and/or other graphic (e.g., a progress bar) can be displayed on mobile device 801 that indicates the distance from the PuDo location, which decreases as the user gets closer to the PuDo location. In an embodiment, the distance can be determined using GNSS data, location data based on wireless networks (e.g., WIFI, cell tower) or motion sensor data (e.g., acceleration and gyro/heading data for dead reckoning) obtained/computed from/by mobile device 801.

Referring to FIG. 8C, when the user is within a threshold distance of the PuDo location, direction indicating graphic 806 (e.g., a compass, direction arrow) appears on the display of mobile device 801 and points in the direction of the PuDo location.

Referring to FIG. 8D, when the user arrives at the PuDo location the user, or a camera on mobile device 801 can search for end marker 803 that marks the exact PuDo location. End marker 803 can be physical signage and/or AR marker. End markers 803 can be landmarks, such as a building, a traffic light or any other physical structure.

Referring to FIG. 8E, while waiting for their vehicle to arrive at the PuDo location, in an embodiment AR beacon 807 (e.g., similar to a spotlight) is projected on the mobile device display to indicate the vehicles current location (e.g., projected over the vehicle’s location), allowing the user to mobile device 801 to track the vehicle’s progress towards the PuDo location. The AR beacon 807 can also enhance navigation for the user to the PuDo location if the vehicle arrives at the PuDo location before the user.

The embodiment described above in reference to FIGS. 8A-8E provides several advantages and benefits, including but not limited to: 1) improved navigation through use of a mix of mobile device applications and improved positioning technology; 2) providing backup guidance to GPS using photos of the PuDo location and end marker signage in the event of GPS failure (e.g., loss of GPS signals in dense urban environments); and 3) managing user expectations by persistently communicating context and current location of the vehicle and the PuDo location. The advantages and benefits described above collectively make it easier for users to distinguish their PuDo locations from another PuDo locations, particularly in contexts where multiple PuDo locations are close to each other.

FIG. 9 illustrates a system 900 for accessing a vehicle using hand gestures (e.g., ASL hand gestures). When a prospective user enters a conventional taxi, the driver unlocks the vehicle, verifies the user’s identify and confirms the user’s destination. Existing access solutions require use of the user’s mobile device to authenticate the user and unlock the vehicle for user entry, or using an RVA to gain access. There are many situations, however, where the user’s mobile device is unavailable, such as being lost or out of battery power. In these situations, hand-gesture entry can be used to provide a seamless way for the user to link a vehicle to their user profile using, for example, NFC communication and a sequence of user hand gestures to unlock the AV. Once unlocked, an external display (e.g., an LED display attached to a B-pillar or other vehicle structure, LED/laser projection on the ground outside vehicle) provides an additional visual cue that the vehicle is unlocked.

In an embodiment, system 900 determines, based on sensor data (e.g., video, 3D depth data), a user’s location relative to vehicle 200, and opens at least one door closest to the user’s location to ensure the door does not open into traffic or some other dangerous condition. In an embodiment, a notification of the door opening is displayed by the external display (e.g., an LED display attached to a B-pillar or other vehicle structure, LED/laser projection on the ground outside vehicle, etc.) on the exterior of the vehicle 200 prior to opening the door.

Referring to FIG. 9, an example embodiment is shown of vehicle 200 (e.g., an AV) including access device 902 attached to the B-pillar or other structure of vehicle 200. Access device 902 can include at least one embedded processor, memory, a touch-sensitive display 903 (e.g., touch-sensitive LCD display) for receiving user touch input and displaying content and at least one camera 904. As the user approaches vehicle 200, short a range wireless communication link is established (e.g., an NFC connection, Bluetooth connection, WIFI connection) between access device 902 and mobile device 502 to link the user with their profile stored on their mobile device 502. The user performs a sequence of hand gestures in front of camera 904. The processor in access device 902 analyzes the sequence of hand gestures captured by camera 904 and/or other sensors, such as LiDAR.

In an embodiment, a local or remote machine learning (ML) program 905 (e.g., a deep neural network trained on video data or images of hand gestures and hand gesture sequences) predicts and labels the sequence of hand gestures that were captured by camera 904. In an embodiment, the output of ML program 905 is a video data stream 906 of a labeled sequence of hand gestures and respective confidence scores (e.g., probabilities of correct labeling), which is transmitted by communication device 202e (e.g., a wireless transmitter) in vehicle 200 to network-based computing system 907 (e.g., fleet management system 116, remote AV system 114) via AV compute 400. AV compute 400 can add additional data, such as a timestamp, location data, VIN number, camera data, biometric data (e.g., face image, fingerprint, voiceprint) captured by access device 902 and/or mobile device 502 that can be sent to network-based service 904 to further assist in authentication of the user.

In an embodiment, one or both of AV compute 400 and network-based computing system 907 analyzes the information to authenticate the user and the gestures and gesture order, and if authenticated successfully, sends an unlock command to vehicle 200 to unlock one or more doors and/or the trunk, depending whether vehicle 200 is picking up passengers and/or cargo.

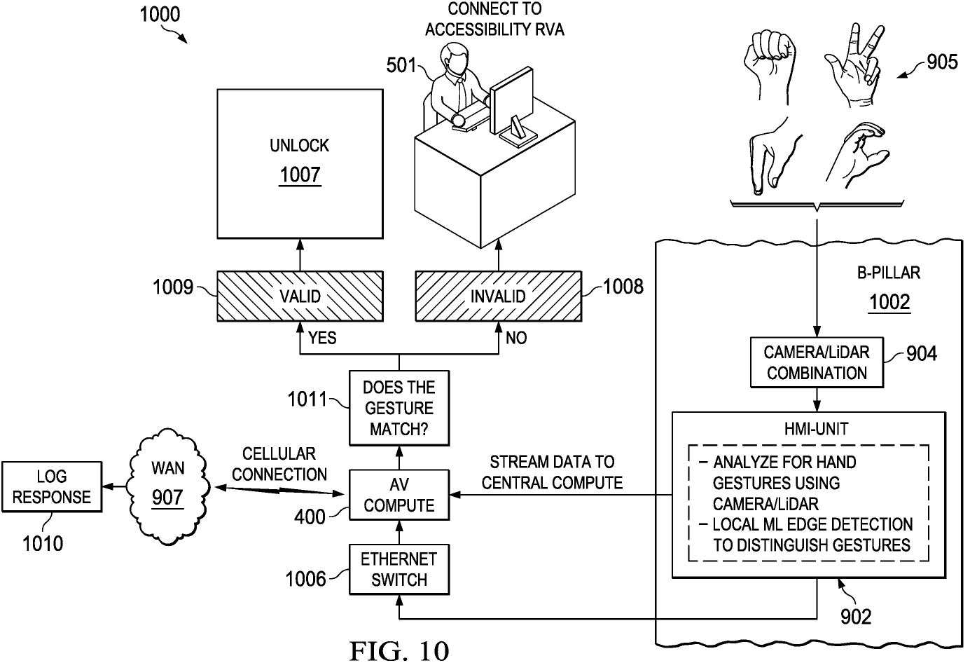

FIG. 10 illustrates a process flow 1000 for accessing a vehicle (e.g., vehicle 200) using a sequence of hand gestures 905. Hand gestures 905 are captured by a camera 904 or a LiDAR or a combination of camera 904 and LiDAR, which are coupled to access device 902, which in this example is attached to B-pillar 1002 of vehicle 200. Hand gestures 905 can be a sequence of ASL gestures, or other hand signals performed in a specific order determined by the user. For example, hand gestures 905 can include a sequence of four ASL hand gestures which represent words, letters, numbers or objects. Hand gestures 905 can include gestures made with both hands or a single hand. A hand gesture includes gestures made by one or more fingers of either hand even if the hand motion is static. In embodiment, facial expressions or head gestures can be used to accommodate amputees and users whose hands are occupied (e.g., carrying groceries or a baby).

In an embodiment, a processor in access device 902 analyzes camera images of hand gestures 905 using the ML program, previously described above. Access device 905 streams the images of the hand gestures 905 to AV compute 400 via an Ethernet switch 1006 or other communication channel (e.g., controller area network (CAN) bus). AV compute 400 compares the gestures to the previously sequence of gestures stored in the user’s profile. In an embodiment, the stored sequence of gestures are selected by the user during an initialization procedure. An example initialization procedure can include providing instructions to the user through display 903 of access device 902 or mobile device 502 to select a series of hand gestures from a set of default hand gestures, with an image or graphic showing each hand gesture (e.g., showing ASL hand gestures). The default sequence of hand gestures are used to train offline the ML model (e.g., recurrent neural network) used by the ML program, such that when the user performs the hand gestures in front of camera 904 to gain real-time access to the vehicle, the ML program can detect the sequence of hand gestures 905 using the ML model (e.g., recurrent neural network) trained on the training images.

In an embodiment, the ML program outputs a label for each hand gesture in the sequence 905 and a confidence score indicating the confidence in the accuracy of the label. The confidence score can be a probability. For example, the ML program can output 4 labels for a sequence of 4 ASL hand gestures and their respective probabilities. Each probability is compared to a threshold probability (e.g., 90%), and if all the probabilities are above the threshold probability and the hand gestures are performed in the order indicated in the user profile, the sequence of hand gestures is determined to be matched.

The ML model can be trained by a variety of images of each hand gesture taken from different angles, perspectives, distances, lighting conditions, etc., to improve the accuracy of the ML model. In an embodiment, the ML model can be trained to detect the sequence of hand gestures as a whole sequence rather than each hand gesture individually.

If the sequence of hand gestures matches the sequence of hand gestures stored in the user profile to within a threshold value (e.g., a probability for a predicted label that is greater than a specified probability threshold), and the hand gestures are performed in the correct order as indicated by the user profile, AV compute 1400 unlocks one or more doors of vehicle 200 to allow the user to enter.

If the sequence of hand gestures 905 performed by the user does not match the sequence of hand gestures stored in the user’s profile after N attempts (e.g., N=3 attempts), or are performed in a different order than indicated in the user profile, AV compute 400 keeps the doors locked and automatically connects the user to RVA 501 through access device 902 or communication interface 314 (FIG. 3), so that the user can speak with a human teleoperator or virtual digital assistant who can authenticate the user using passwords or other authentication data, and if authentication is successful issue a command to AV compute 400 to unlock one or more doors of vehicle 200.

In an embodiment, in addition to, or in lieu of hand gestures, RVA 501 or access device 902 and/or AV compute 400 can use camera 904 or another camera and/or TOF sensor to capture the face of the user, and use a face recognition program to authenticate the user based on facial landmarks detected in the data. In an embodiment, the user can be authenticated by having touch a fingerprint sensor on display 903 or other area of access device 902 or vehicle 200. In an embodiment, AV compute 400 connects to network-based computing system 907 through, for example, a cellular connection, to retrieve the user profile including the stored hand gesture data and to log the access attempt. In an embodiment, ML program can be run entirely or partially by network-based computing system 907.

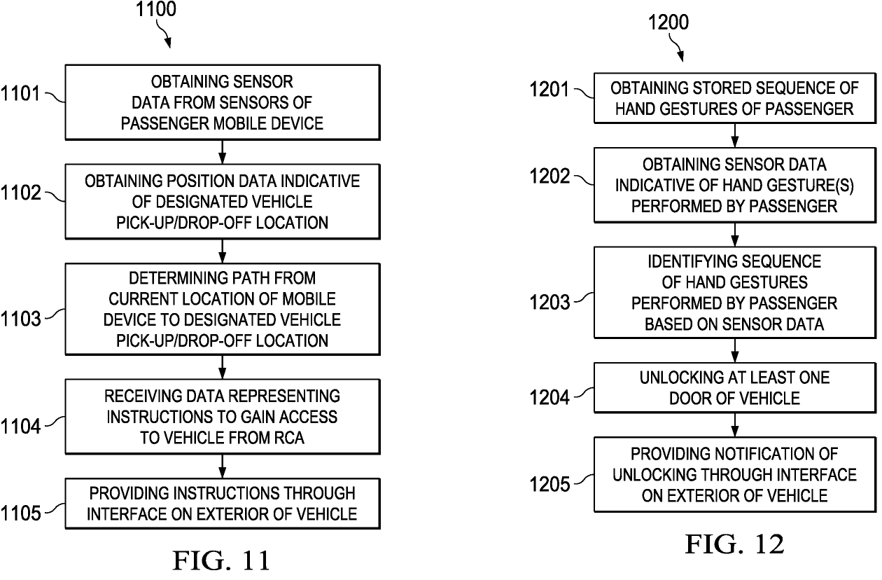

FIG. 11 is a flow diagram of a process 1100 for navigating to a vehicle, according to one or more embodiments. Process 1100 can be performed by, for example, processor 304 shown in FIG. 3.

Process 1100 can include the steps of obtaining, from sensors of a mobile device of a user, sensor data indicative of a location of the mobile device (1101), obtaining, by at least one processor of the mobile device, position data indicative of a designated vehicle pickup position (1102), determining, by the at least one processor of the mobile device, based on the sensor data and the position data, a path from the current location of the mobile device to the designated vehicle PuDo location (1103), determining, by the at least one processor of the mobile device, based on the path, a set of instructions to follow the path (1104) and providing, using an interface of the mobile device, by the at least one processor of the mobile device, information comprising an indication associated with the designated vehicle PuDo location; and a set of instructions to follow the path based on the current location of the mobile device (1105). Each of these steps were previously described more in reference to FIGS. 8A-8E.

FIG. 12 is a flow diagram of a process 1200 for accessing a vehicle using hand gestures, according to one or more embodiments. Process 1200 can be performed by, for example, processor 304 shown in FIG. 3.

Process 1200 can include the steps of obtaining, by at least one processor of a vehicle, a stored sequence of hand gestures of a user (1201), obtaining, by the at least one processor, sensor data associated with at least one hand gesture performed by the user (1202), identifying, by the at least one processor, a sequence of hand gestures performed by the user based on obtaining the sensor data (1203), comparing, by the at least one processor, the sequence of hand gestures performed by the user and the stored sequence of hand gestures based on identifying the sequence of hand gestures performed by the user and the stored sequence of hand gestures (1204), determining, by the at least one processor, that the sequence of hand gestures performed by the user matches the stored sequence of hand gestures of the user based on comparing the sequence of hand gestures performed by the user and the stored sequence of hand gestures (1205), and unlocking, by the at least one processor, at least one door of the vehicle based on determining that the sequence of hand gestures performed by the user matches the stored sequence of hand gestures of the user (1206). Each of these steps were previously described in reference to FIGS. 9 and 10.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A method, comprising:
obtaining, from sensors of a mobile device of a user, sensor data indicative of a location of the mobile device;
obtaining, by at least one processor of the mobile device, position data indicative of a designated vehicle pickup/drop-off location;
determining, by the at least one processor of the mobile device, based on the sensor data and the position data, a path from the current location of the mobile device to the designated vehicle pickup/drop-off location;
determining, by the at least one processor of the mobile device, based on the path, a set of instructions to follow the path;
providing, using an interface of the mobile device, by the at least one processor of the mobile device, information comprising:
an indication associated with the designated vehicle pickup/drop-off location; and
a set of instructions to follow the path based on the current location of the mobile device.

2. The method in claim 1, further comprising:
determining a distance from the current location of the mobile device to the designated vehicle pickup/drop-off location based on the path; and
providing, using the interface of the mobile device, information comprising a distance from the current location of the mobile device to the designated vehicle pickup/drop-off location.

3. The method in claim 1, wherein the indication is associated with at least one of a physical feature located in an environment or an augmented reality (AR) marker located relative to at least one object in the environment.

4. The method in claim 3, wherein the AR marker is unique within a geographical region and is associated with the arriving vehicle scheduled to arrive at the designated vehicle pickup/drop-off location.

5. The method in claim 1, wherein the set of instructions comprises a set of visual cues overlaid onto live video feed of an environment.

6. The method in claim 1, wherein the set of instructions comprises an augmented reality (AR) compass pointing in the direction of the designated vehicle pickup/drop-off location.

7. The method in claim 5, wherein the AR compass is displayed when the mobile device is within a threshold distance of the designated vehicle pickup/drop-off location.

8. The method in claim 1, wherein the path from the current location of the mobile device to the designated vehicle pickup/drop-off location is determined at least in part by a network-based computing system.

9. The method in claim 1, wherein the set of instructions is determined at least in part by a network-based computing system.

10. The method in claim 2, wherein the distance from the current location of the mobile device to the designated vehicle pickup/drop-off location is determined at least in part by a network-based computing system.

11. The method in claim 1, wherein the set of instructions is determined at least in part by a network-based computing system.

12. The method in claim 1, wherein the sensor data comprises at least one of satellite data, wireless network data or location beacon data.

13. The method of claim 1, further comprising updating, by the at least one processor of the mobile device, the provided information based on a new location of the mobile device.

14. A method, comprising:
obtaining, by at least one processor of a vehicle, a stored sequence of hand gestures associated with a user profile;
obtaining, by the at least one processor, sensor data associated with a sequence of hand gestures performed by the user;
identifying, by the at least one processor, the sequence of hand gestures performed by the user based on the sensor data;
comparing, by the at least one processor, the sequence of hand gestures performed by the user and the stored sequence of hand gestures;
determining, by the at least one processor, that the sequence of hand gestures performed by the user matches the stored sequence of hand gestures based on the comparing; and
unlocking, by the at least one processor, at least one door of the vehicle based on determining that the sequence of hand gestures performed by the user matches the stored sequence of hand gestures.

15. The method of claim 14, further comprising providing a notification of the unlocking through an interface on the exterior of the vehicle.

16. The method of claim 14, further comprising:
determining based on the sensor data, a user location relative to the vehicle; and
opening the at least one door closest to the user location.

17. The method of any of claims 16, further comprising providing a notification of the opening through an interface on the exterior of the vehicle prior to the opening.

18. The method of claim 14, further comprising:
determining, based on a request from the user, that the user requires remote assistance;
contacting remote vehicle assistance (RVA) based on determining that the user requires RVA;
receiving, from the RVA, data associated with instructions to gain access to the vehicle; and
providing the instructions through the interface on the exterior of the vehicle.

19. The method of claim 14, wherein the stored sequence of hand gestures is obtained at least in part based on data from a short-range communication device.

20. The method of claim 14, wherein identifying the sequence of hand gestures performed by the user is based on a machine learning model.

21. The method of claim 20, wherein the machine learning model is a neural network.

22. The method of claim 14, wherein identifying the sequence of hand gestures performed by the user comprises identifying, using a remote system, at least one gesture in the sequence of gestures performed by the user.
